(19) United States
(12) Patent Application Publication
(10) Pub. No.: US 2016/0380275 A1
(43) Pub. Date: Dec. 29, 2016

(54) MULTI-VOLTAGE FUEL CELL

(71) Applicant: Hamilton Sundstrand Space Systems International, Inc., Windsor Locks, CT (US)

(72) Inventors: David G. Converse, Hampden, MA (US); Thomas J. Lezon, Ellington, CT (US)

(21) Appl. No.: 14/566,738

(22) Filed: Dec. 11, 2014

(51) Int. Cl. H01M 8/0247; H01M 8/241

(52) U.S. Cl. CPC H01M 8/0247; H01M 8/241; H01M 2250/20; H01M 2008/1095

(57) ABSTRACT

A fuel cell stack has a first end plate, a second end plate, and an internal current collecting plate. A first load is connected to the first end plate and the second end plate. A second load is connected to the first end plate and the internal current collecting plate.

### STATEMENT REGARDING FEDERALLY SPONSORED RESEARCH OR DEVELOPMENT

This invention was made with government support under Contract No. N00014-12-D-0372-0001, awarded by the United States Navy. The Government has certain rights in this invention.

### BACKGROUND

This application relates to a fuel cell.

A fuel cell is a device that converts chemical energy of a fuel into electrical energy, typically by oxidizing the fuel. In general, a fuel cell includes an anode and a cathode which are catalyst layers on opposite sides of an electrolytic membrane. When fuel is supplied to the anode and oxidant is supplied to the cathode, the membrane assembly generates a useable electric current that is passed through an external load. In one widely used type of fuel cell, the fuel supplied is hydrogen and the oxidant supplied is oxygen. In such cells, the electrolyte combines the oxygen and hydrogen to form water and to release electrons.

Fuel cells often are arranged as a multi-cell assembly or “stack.” In a multi-cell stack, multiple cells are connected together in series. The number of single cells within a multi-cell assembly are adjusted to increase the overall power output of the fuel cell. Typically, the cells are connected in series with one side of a fluid flow plate acting as the anode for one cell and the other side of the fluid flow plate acting as the cathode for an adjacent cell. Power is supplied by connecting a circuit to end plates arranged at each end of the repeating cells.

Electrical systems often use different voltages, such as one voltage for power transmission, another voltage for signals and yet another voltage for actuators. Typical known electrical supply systems, such as fuel cells, supply electricity at a single voltage. Additional power supplies are used to change the cell voltage to other voltage levels required by the system.

### SUMMARY

A fuel cell stack has a first end plate, a second end plate, and an internal current collecting plate. A first load is connected to the first end plate and the second end plate. A second load is connected to the first end plate and the internal current collecting plate.

The various features and advantages of this invention will become apparent to those skilled in the art from the following detailed description of an embodiment. The drawings that accompany the detailed description can be briefly described as follows.

### BRIEF DESCRIPTION OF THE DRAWINGS

FIG. 1 shows a schematic view of an example fuel cell stack according to a first embodiment.

FIG. 2 shows a schematic view of an example fuel cell stack according to a second embodiment.

### DETAILED DESCRIPTION

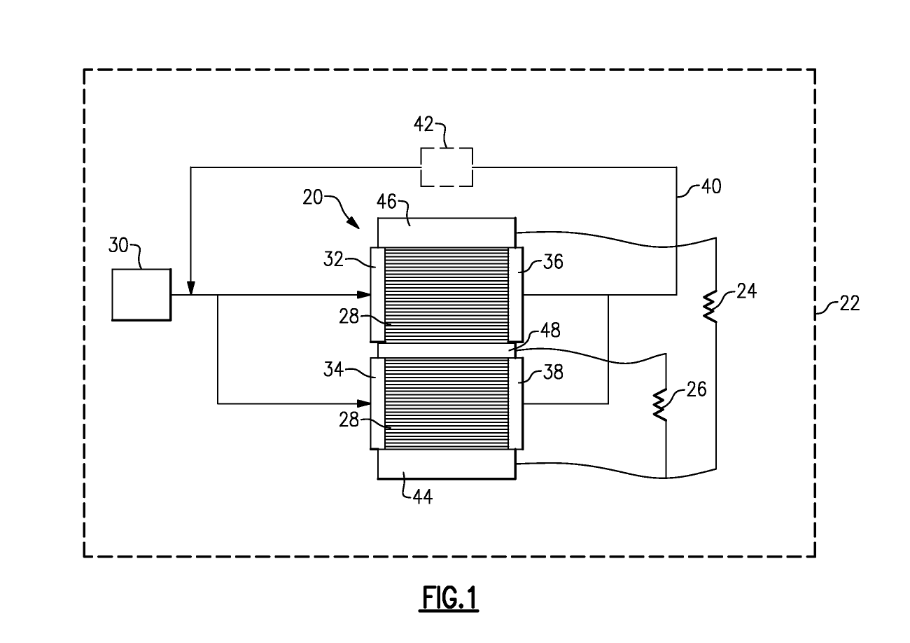

FIG. 1 illustrates a fuel cell stack 20 shown schematically mounted within an exemplary vehicle 22. In one example, the vehicle 22 is an Unmanned Underwater Vehicle (UUV). In another example, the vehicle 22 is an Unmanned Aerial Vehicle (UAV). However, other vehicles and systems are contemplated, including ground and space systems, manned and unmanned systems, hybrid systems, and stationary systems.

The fuel cell stack 20 is configured to provide power to loads 24, 26 within the vehicle 22. Loads 24, 26 may include one or more propulsion systems and/or electrical components, such as controllers and sensors.

The fuel cell stack 20 includes a plurality of fuel cells 28 for generating power by converting chemical energy into electrical energy. Each of fuel cells 28 comprises an anode, a cathode, and an electrolyte. In some examples, each of the fuel cells 28 comprises a proton exchange membrane (PEM). Other conventional fuel cell arrangements are contemplated, including metal hydride fuel cells, solid oxide fuel cells (SOFC), alkali fuel cells, molten carbonate fuel cells (MCFC) and phosphoric acid fuel cells (PAFC).

Additionally, the fuel cells 28 can include the same active area or different active areas to generate different amounts of power.

In an embodiment, each fuel cell 28 provides 0.6-0.9 V. Multiple fuel cells 28 are electrically connected in series to produce a stack voltage to meet the needs of the particular system.

The fuel cell stack 20 receives fuel or reactant such as hydrogen (H₂) from a fuel source 30, such as a tank. The fuel flows into fuel passages 32, 34 and through the fuel cells 28, where the fuel interacts with the anode of each fuel cell 28 and is consumed converting chemical energy into electrical energy. Similarly, an oxygen containing gas (not shown) passes along the cathode of each fuel cell 28. Excess fuel that is not consumed in the fuel cells 28 exits the fuel cells 28 through passages 36, 38. In an embodiment, this fuel is recycled back to fuel source 30 to be reused in the fuel cell stack 20 in an anode recycle loop 40. In a further embodiment, a pump 42 facilitates the flow of fuel from passages 36, 38 back to the fuel passages 32 and 34. The pump 42 may be a blower or an ejector, for example.

The anode recycle loop 40 helps to ensure that there is always flow across the anode of each fuel cell 28. For example, the fuel cell 28 may be designed to consume only 80%-95% of the fuel to prevent localized starvation, which may damage the fuel cell 28. The excess fuel from passages 36, 38 is reused in the fuel cell stack 20. In an embodiment, loads 24, 26 may cause a fuel imbalance across the anodes of fuel cells 28, so excess fuel from passages 36, 38 is combined before being recycled back to fuel source 30, to provide a more uniform fuel concentration across the fuel cells 28.

The fuel cell stack 20 has a first end plate 44 and a second end plate 46 at either end of the plurality of fuel cells 28, and an intermediate-stack or internal current collecting plate 48 inserted among the fuel cells 28. The first load 24 is connected between the first end plate 44 and second end plate 46 such that the entire stack voltage is applied across load 24. The second load 26 is connected between the first end plate 44 and the internal current collecting plate 48 such that a portion of the stack voltage is applied across the second load 26. This arrangement allows for the fuel cell stack 20 to provide two different voltage levels to two different loads 24, 26 simultaneously.

The internal current collecting plate 48 may be aluminum gold-plated or stainless steel gold-plated, for example. However, other plate materials are contemplated. The internal current collecting plate 48 may be the same material as the first and second end plates 44, 46, or may be a different material.

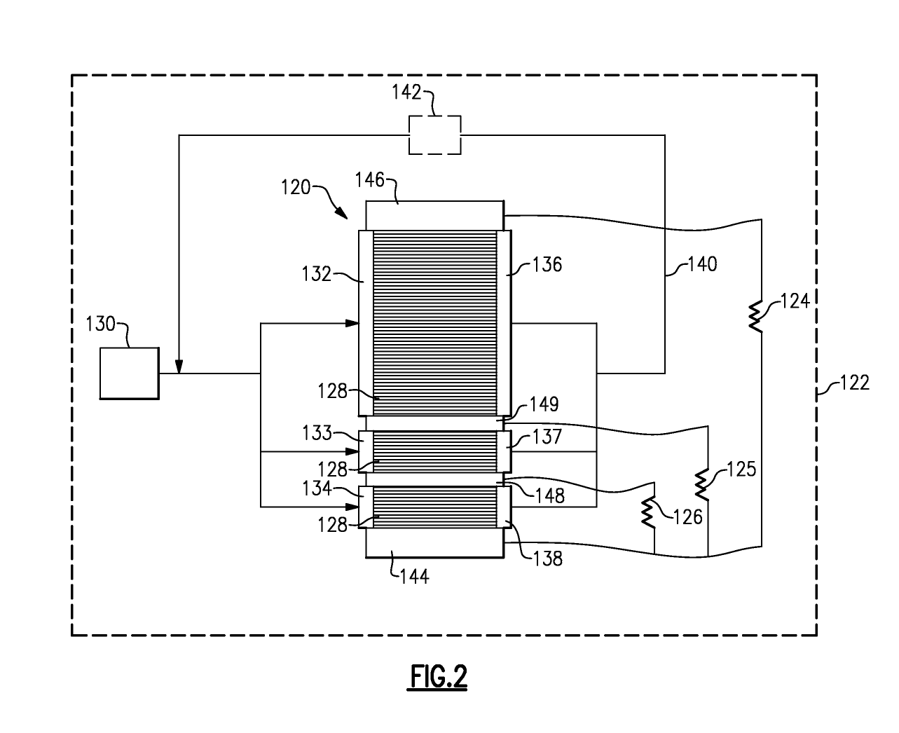

FIG. 2 shows a schematic view of a second embodiment of a fuel cell stack 120. In this disclosure, like reference numerals designate like elements where appropriate and reference numerals with the addition of one-hundred or multiples thereof designate modified elements that are understood to incorporate the same features and benefits of the corresponding original elements.

In further embodiments, additional internal current collecting plates 149 are inserted among the fuel cells 128. There could be as many internal plates 148, 149 as one less than the number of fuel cells 128. In the illustrated example, there are two internal current collecting plates 148, 149, such that the fuel cell stack 120 provides three different voltage levels simultaneously. In this embodiment, each load is connected to the first end plate 144 and either the second end plate 146 for the full stack voltage, or the internal current collecting plate 148, 149 that is positioned at the desired voltage. For example, the fuel cell stack 120 may provide 60 V to a first load 124, such as power transmission, 24 V to a second load 124, such as controllers or actuators, and 12 V to a third load 126, such as sensors.

The use of multiple internal current collecting plates 148, 149 eliminates the need for power conversion devices to raise or lower voltage to the desired level for systems requiring different voltages. This elimination of power conversion devices saves on additional hardware weight and volume as well as improving overall system efficiency by eliminating power conversion losses. Higher efficiency and lower weight allow for longer mission durations between refueling.

Although the different examples have a specific component shown in the illustrations, embodiments of this disclosure are not limited to those particular combinations. It is possible to use some of the components or features from one of the examples in combination with features or components from another one of the examples.

Furthermore, the foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A fuel cell stack, comprising:
a first end plate;
a second end plate; and
an internal current collecting plate arranged in the fuel cell stack between the first end plate and the second end plate, wherein a first load is connected to the first end plate and the second end plate, and a second load is connected to the first end plate and the internal current collecting plate.

2. The fuel cell stack of claim 1, wherein the first load and the second load are supplied two different voltages simultaneously.

3. The fuel cell stack of claim 2, wherein the first load operates at a high voltage, and the second load operates at a lower voltage.

4. The fuel cell stack of claim 1, wherein the fuel cell stack comprises hydrogen fuel cells.

5. The fuel cell stack of claim 4, wherein the hydrogen fuel cells comprise proton exchange membrane cells.

6. The fuel cell stack of claim 1, comprising an anode recycle loop configured to direct a flow of fuel exiting the fuel cell stack to a fuel source for reuse in the fuel cell stack.

7. The fuel cell stack of claim 1, wherein the internal current collecting plate is stainless steel gold-plated.

8. The fuel cell stack of claim 1, wherein the first load and the second load are components of an Unmanned Underwater Vehicle.

9. The fuel cell stack of claim 1, wherein the first load and the second load are components of an Unmanned Aerial Vehicle.

10. A method of powering multiple loads, comprising:
providing a fuel cell stack having a first end plate, a second endplate, and an internal current collecting plate arranged between the first end plate and the second endplate;
connecting a first load to the first end plate and the second endplate; and
connecting a second load to the first end plate and the internal current collecting plate.

11. The method of claim 10, wherein the first load and the second load operate at different voltages simultaneously

12. The method of claim 11, wherein the first load operates at a high voltage and the second load operates at a lower voltage.

13. The method of claim 10, wherein the fuel cell stack comprises hydrogen fuel cells.

14. The method of claim 10, wherein the first load and the second load are electrical components of an Unmanned Underwater Vehicle.

15. The method of claim 10, wherein the first load and the second load are electrical components of an Unmanned Aerial Vehicle.
